(19) United States
(12) Patent Application Publication
(10) Pub. No.: US 2010/0243482 A1
(43) Pub. Date: Sep. 30, 2010

(54) Biological specimen of electron microscope

(76) Inventor: Chih-Yu Chao, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/453,952

(22) Filed: May 28, 2009

(30) Foreign Application Priority Data
Mar. 27, 2009 (TW) 098110048

(51) Int. Cl. G01N 27/26; G01N 27/327

(52) U.S. Cl. 205/792; 204/403.01

(57) ABSTRACT

The invention relates to a method and apparatus for forming the biological specimen of electron microscope. The invention carries out the rapid freezing and the cryogenic electrochemical doping to the biological specimen, so that the biological specimen has the behavior close to the conductor, which can be used to achieve the observation of biomolecules at a higher resolution using electron microscope. The invention will reduce the radiation damage of the biomolecules and the surrounding amorphous ice under electron beam irradiation, and the invention will clearly observe the prototype of the biomolecules.

### BACKGROUND OF THE INVENTION

1. Field of the Invention

The invention relates to a method and apparatus for forming the specimen of cryo-electron microscope, particularly to a method and apparatus for forming the biological specimen of cryo-electron microscope.

2. Description of the Prior Art

Conventionally, the cryo-electron microscopy can be employed to observe the protein structure. The hydrated biological molecules can be frozen quickly and embedded in the amorphous ice to form the observable biological specimen. However, due to there is no free electron inside the amorphous ice, thus the biological specimen does not have good electric conductivity. Under electron beam irradiation, the permanent and irrecoverable radiation damage will be generated. Thus the amorphous-ice biological specimen is not like the metal specimen that can tolerate a much higher electron dosage. At present, the restriction of electron dosage of the amorphous-ice biological specimen is about 10-20 e/A². That is, too much electron dosage will damage the biomolecules and biomaterials. The damaged molecule fragments will generate the slight displacement or motion, which will cause a blurring effect in the image and lose the atomic resolution. Thus the cryo-electron microscopy does not have the good practicability.

However, after the aqueous solution doped with a certain amount of sodium and chlorine ions and rapidly frozen at the cryogenic environment, the energy gap of the doped amorphous ice will be reduced greatly to form an intrinsic semiconductor with better conductive property. However, the product of the numbers of electrons and holes is still a constant value in the intrinsic semiconductor. Thus the N-type or P-type doping is necessary to be conducted to increase the number of free electrons or holes, so that the amorphous ice will have the behavior close to the conductor. However, if the N-type or P-type doping is conducted for the amorphous-ice biological specimen, the ice-embedded biological specimen needs to be kept at the cryogenic temperature and cannot be melted during the doping process. Thus, the conventional solution doping method or molten doping method is not feasible.

In addition, if the chemical vapor doping method is used, the amorphous-ice biological specimen will be exposed in the halogen vapor environment. The halogen molecules will be diffused into the amorphous-ice biological specimen, which will cause the water molecules in the amorphous ice to lose electrons, and be dissociated into hydrogen ions (H⁺) and oxygen atoms. Thus this kind of vapor doping method still cannot be used to generate the free mobile carriers in the amorphous-ice biological specimen. On the other hand, if the amorphous-ice biological specimen is exposed in the sodium vapor, because sodium is a kind of metals, thus sodium is easier to form the crystalline nuclei and then a film on the surface of amorphous ice. Therefore, only some sodium vapor can be diffused into the amorphous-ice biological specimen to generate the electron transfer with water molecules. However, when the defect of water molecules around the sodium atom traps the electron, it will be dissociated into the hydroxyl ion (OH⁻) and hydrogen atom immediately. Thus, it also cannot be used to generate the free mobile carriers.

In the practice of electron microscope, the amorphous-ice biological specimen mainly loses electrons (oxidation reaction) under the irradiation of electron beam, due to the bonded electrons will be dissociated by the electron radiation. Thus the specimen doped with a certain amount of antioxidant (namely as N-type doping) can promptly return electrons to the ionized atoms and molecular fragments to repair and scavenge the radiation damage of the biological specimen under electron beam exposure. However, so far it is not feasible to carry out N-type doping (for example, the sodium ion doping) for the amorphous-ice biological specimen without damaging the biological molecules and generating the hydroxyl ions (OH⁻) dissociated from water molecules upon sodium (or sodium ion) doping the amorphous ice. Nobody can provide the precise and feasible method at present. And the traditional plasma doping and ion implantation will damage the protein molecules in amorphous-ice biological specimen seriously.

Therefore, it is necessary to develop better electron microscopy to carry out the observation of protein structure.

### SUMMARY OF THE INVENTION

The invention can form N-type doping in the amorphous-ice biological specimen. In the operation, it will not cause the water molecules in the amorphous ice to trap electrons and be dissociated into the hydroxyl ions, and will not damage the structure of biological molecule.

The invention relates to a method for forming N-type doped amorphous-ice biological specimen. Different doping procedure is carried out before and after rapid freezing the biological molecule solution. Firstly, a certain amount of suitable electrolyte is doped in the biological molecule solution, so that the biological molecule solution after rapid freezing will become the electrolyte ions doped amorphous-ice biological specimen and own the characteristics of semiconductor. Then, after rapid freezing the biological molecule solution, the electrochemical doping (ECD) is employed to dope the amorphous-ice biological specimen at the cryogenic temperature. After a certain amount of cation doping, the N-type doped amorphous-ice biological specimen will own the behavior close to the conductor.

The invention can reduce the radiation damage of the amorphous-ice biological specimen under the irradiation of electron beam, and can observe the prototype of biomaterials clearly.

The invention can break through the key technology of electron microscopy, so that it can successfully develop the bio-molecular electron microscope with atomic resolution.

The invention can raise the resolution of electron microscopy by saving the cost. Only the relevant key technology can be developed to raise the resolution of any electron microscope.

The main advantage of the invention is that the fabrication of component is easy, thus it can be used to observe different proteins, and can be applied in the relevant fields, such as biology, medicine, and biochemistry etc.

The invention makes N-type doped amorphous ice having the property of conductor, which can reduce the radiation damage of the amorphous-ice biological specimen under the irradiation of electron beam, and can offer enough electron dosage to observe the prototype of biomaterials clearly.

The advantage and spirit of the invention can be understood further by the following detail description of invention and attached Figures.

### BRIEF DESCRIPTION OF THE DRAWINGS

The foregoing aspects and many of the attendant advantages of this invention will become more readily appreciated as well becomes better understood by reference to the following detailed description, when taken in conjunction with the accompanying drawings, wherein:

FIG. 1 illustrates the cross-sectional diagram of magnified specimen grid.

FIG. 2 illustrates the specimen grid fixed to the bottom of specimen electrode bar.

FIG. 3 illustrates the first preferred embodiment of the present invention.

FIG. 4A illustrates the second preferred embodiment of the present invention.

FIG. 4B illustrates the reaction theory of the present invention.

FIG. 5A illustrates the energy band diagram of the lowest unoccupied molecular orbital (LUMO) formed by the sodium ions and the polarized water molecules, and the highest occupied molecular orbital (HOMO) formed by the polarized water molecules.

FIG. 5B illustrates the energy band diagram of lithium ion doped amorphous ice, in which Fermi level is raised by lithium ion doping, and Na+ conduction band is formed by the sodium ions and the polarized water molecules near lithium ions and sodium ions.

FIG. 6 illustrates the radial probability distribution of the electron wavefunction bound around sodium ion in the amorphous ice.

FIG. 7 illustrates the radius range of the electron wavefunction around each sodium ion and uniform distribution state of sodium ions and chlorine ions in the amorphous ice.

FIG. 8 illustrates the extent of the spread of the electron wavefunctions around sodium ions overlaps protein biomolecules embedded in the amorphous ice.

### DESCRIPTION OF THE PREFERRED EMBODIMENT

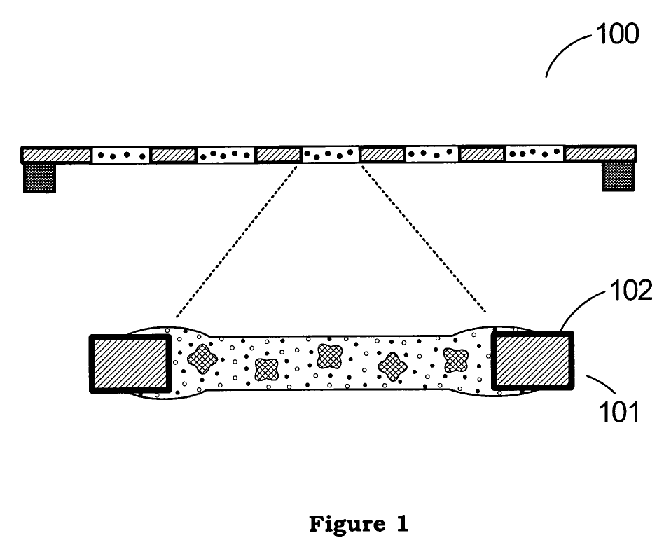

A preferred embodiment of the invention is shown in FIG. 1, which mainly comprises the following steps:

Firstly, add the biological molecules in the sodium chloride (NaCl) solution, which means to immerse the biological molecules such as protein in the sodium chloride solution with suitable concentration. The concentration of sodium chloride solution is between 1 μM and 150 mM. The aqueous solution containing the sodium ions will at least comprise the conduction level close to Fermi level. The conduction level can also be called as the lowest unoccupied molecular orbital (LUMO).

Then, drop the sodium chloride solution containing the biological molecules in the specimen grid. Use the filter paper to remove the surplus solution. It is rapidly frozen to 77K by low-temperature liquid ethane, so that the sodium chloride solution containing the biological molecules becomes the amorphous ice state, and forms the frozen biological specimen (or called the vitrified biological specimen). The ion doping concentration of the frozen biological specimen is 200 μM in the embodiment. However, when the ion doping concentration is too high, as greater than 100 mM, the resolution of electron microscope will be influenced. Thus, if the concentration of original sodium chloride solution is too high, it has to be diluted. The ions adopted for doping in the invention, such as sodium ion and chlorine ion are not heavy metal elements. Their concentrations are controlled below about 100 mM, in order to avoid influencing the contrast and resolution of electron microscope. The thickness of frozen biological specimen shall also be controlled below about 100 nm, in order to prevent multiple scattering of electron and thus influence the resolution of microscope.

As shown in FIG. 1, the cross-section of specimen grid 100 is magnified, and the biological specimen is frozen and stored in specimen grid 100. The shape of specimen grid 100 is holey carbon film, which is made up of the carbon film 101. About 5 nm thick gold film 102 or other metal film can be sputtered on outer surfaces of the carbon film 101, in order to increase the conductivity when applying current to the amorphous-ice biological specimen.

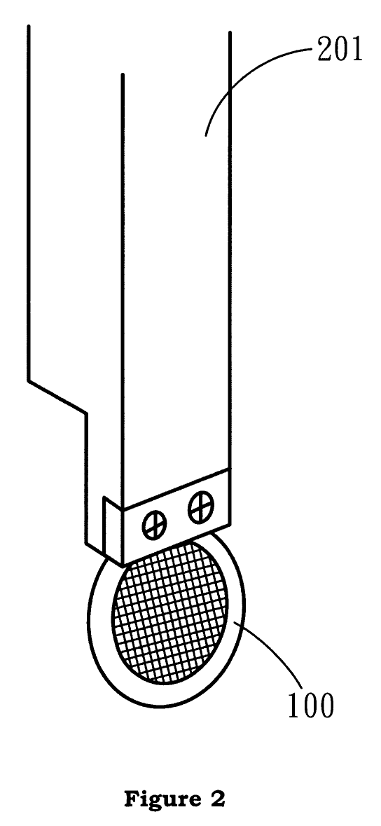

Then, as shown in FIG. 2, the biological specimen frozen in specimen grid 100 shall be transferred and fixed to the bottom of specimen electrode bar 201. At this time, the specimen electrode bar 201 must be kept at about 90K or below to carry out the transferring of the biological specimen.

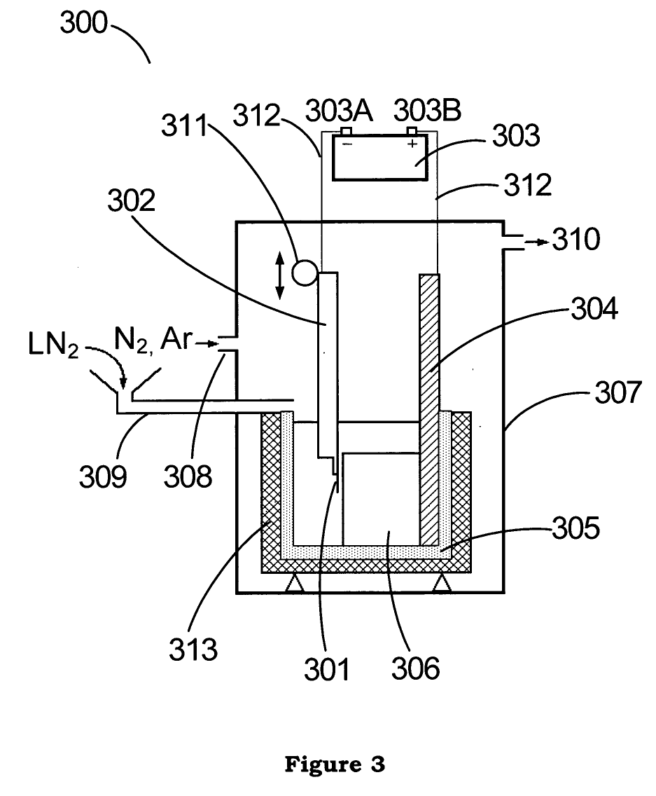

As shown in FIG. 3, the cryogenic electrochemical doping (CryoECD) is carried out to conduct the electrochemical doping of biological specimen 301, which owns the charging function for biological specimen 301. The biological specimen 301 is installed in the cryogenic electrochemical doping apparatus 300 of frozen biological specimen. The biological specimen 301 is an electrode in apparatus 300 (namely the first electrode), which is connected to the cathode 303A of battery 303 by specimen electrode bar 302. In the embodiment, the counter electrode 304 (namely the second electrode) is the lithium electrode, which is connected to the anode 303B of battery 303. Lithium alloy or lithium compound electrode can also be adopted as the counter electrode. During the cryogenic electrochemical doping process, the biological specimen 301 is immersed in the environment of liquid nitrogen all the time. The liquid nitrogen is contained in a container 305, and the container 305 is wrapped by a polystyrene material 313 to increase the insulation.

In addition, the electrolyte 306 used in the invention is lithium tetrafluoroborate (LiBF₄) solid-state polymer electrolyte. Because the solid-state polymer electrolyte is amorphous, the lithium ion (Li⁺) and tetrafluoroborate ion (BF₄_{^{−}}) can move freely in the solid-state polymer at room temperature. However, when it is immersed in the environment of liquid nitrogen, the mobility of larger ion like tetrafluoroborate ion will be reduced greatly or even it cannot move, due to the influence of very low-temperature environment. However, in the invention, the tetrafluoroborate ion only plays the role to maintain the neutrality of electrolyte, which will not have any chemical reaction with the electrode. To the contrary, the lithium ion is not limited, due to its small volume and light mass. It still owns quite high mobility even at very low temperature. In addition, other solid-state polymer electrolytes such as lithium perchlorate (LiClO₄), lithium hexafluorophosphate (LiPF₆), and lithium hexafluoroarsenate (LiAsF₆) etc. can be used in the invention. The above-mentioned electrolytes such as lithium salts etc. can also be dissolved in the suitable pasty solvent firstly. Then curing may be needed for some pasty solvents. Subsequently, put it into the liquid nitrogen to form the solid-state electrolyte material used at cryogenic temperatures. However the pasty solvent after hardening cannot react with the electrode chemically.

Still as shown in FIG. 3, the chamber 307 of apparatus 300 can be totally closed or partially closed or even opened chamber. The nitrogen gas from gas injection tube can be used to directly blow two low-temperature electrodes and the exterior of liquid nitrogen container, in order to avoid forming the frost. The apparatus 300 owns a gas injection tube 308 for the injection of inert gas, such as nitrogen (N₂) or argon (Ar) etc., so that two electrodes immersed in the liquid nitrogen (LN₂) will not be frosted due to the moisture in the air. Due to the cryogenic electrochemical doping process shall be finished in several hours, thus the inert gas with positive pressure has to be injected to purge water vapor out of the chamber 307. It can prevent the moisture from entering liquid nitrogen to form movable ice crystals and contaminate the biological specimen 301. In addition, the injection of inert gas can prevent other pollutants in the air to pollute the liquid nitrogen.

In addition, the liquid nitrogen for maintaining a very low-temperature environment in the chamber 307 is supported by a container wrapped with the polystyrene with excellent insulation property. In the cryogenic electrochemical doping process, it is necessary to supply the liquid nitrogen constantly, so that the biological specimen 301 and the solid-state polymer electrolyte 306 can be immersed in the liquid nitrogen. However, it has to pay attention before the liquid nitrogen from the nozzle 309 entering the chamber 307, a filter paper (or a filter) has to be used to filter the ice crystals produced by the air moisture in contact with liquid nitrogen. The filter paper can prevent the ice crystals from entering the liquid nitrogen container and avoid the contamination of biological specimen 301. The nitrogen gas evaporated from the liquid nitrogen and the surplus inert gas in the chamber 307 can flow out through the vent 310. In addition, in the supply of liquid nitrogen via the nozzle 309, the nitrogen gas can be used to blow the vicinity of the nozzle 309, in order to avoid the occurrence of ice crystals to contaminate the liquid nitrogen. Alternatively, the internal automatic supply way can be adopted to directly inject the liquid nitrogen into the liquid nitrogen container inside the chamber 307. In addition, the knob 311 is used to adjust the elevation of the specimen electrode bar 302, in order to facilitate the fixation and dismantlement of biological specimen 301. The electric wire 312 is used for connecting the battery 303, electrode 302 and electrode 304.

A method for using the above-mentioned cryogenic electrochemical doping apparatus to form the biological specimen, comprising:

Carry out the low-temperature treatment at first, which is to add the low-temperature liquefied coolant in the container of the cryogenic electrochemical doping apparatus. Then the specimen grid containing the biological specimen is sent to the low-temperature liquefied coolant, after it is fixed on the specimen electrode bar. Finally, the cryogenic electrochemical doping is carried out in the biological specimen.

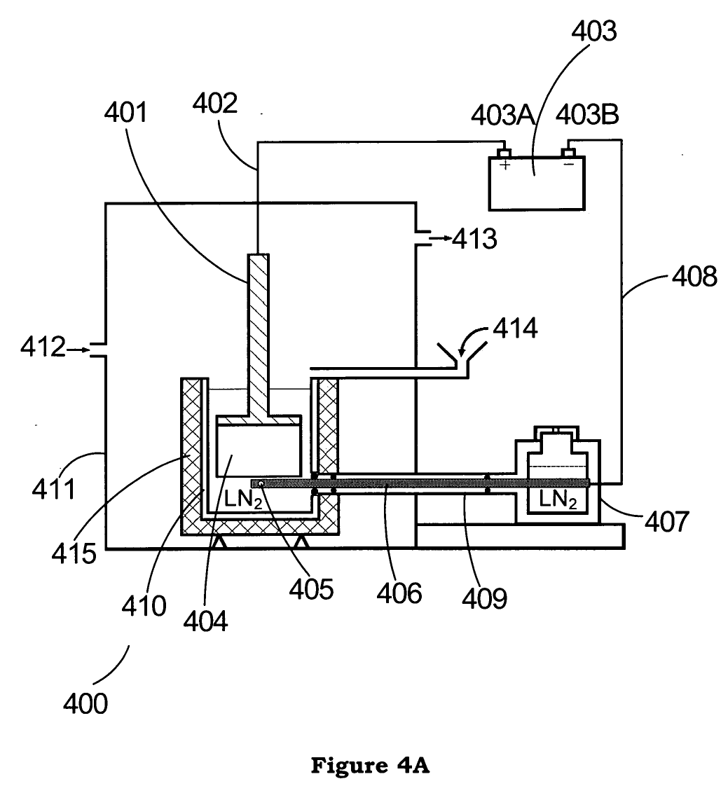

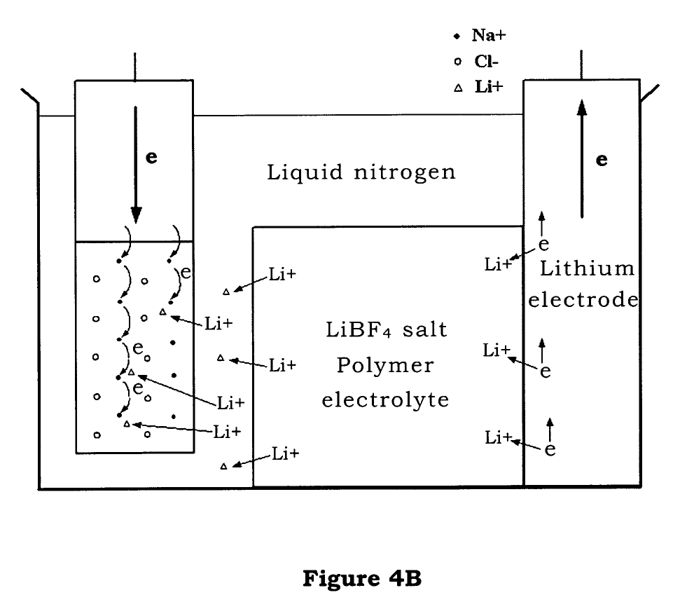

A second preferred embodiment of the invention is shown in FIG. 4A. The apparatus 400 owns a lithium electrode 401 (namely the second electrode), which is connected to the anode 403A of battery 403 through the electric wire 402. The electrolyte 404 is lithium tetrafluoroborate (LiBF₄) solid-state polymer electrolyte. The biological specimen 405 is an electrode (namely the first electrode) in the apparatus 400, which is connected to the cathode 403B of battery 403 through the electric wire 408 from metal bar 406 installed in the Dewar bottle 407 (connected to low-temperature specimen holder 409). The lithium electrode 401, electrolyte 404 and biological specimen 405 are immersed in the environment of liquid nitrogen. The liquid nitrogen is contained in a container 410, and the container 410 is wrapped by a polystyrene material 415 to increase the insulation. The chamber 411 of apparatus 400 can be totally closed or partially closed or even opened chamber. The nitrogen gas from gas injection tube can be used to directly blow the lithium electrode 401 and the exterior of liquid nitrogen container, in order to avoid the formation of frost. The apparatus 400 owns a gas injection tube 412 and the surplus inert gas in chamber 411 can flow out through the vent 413.

The liquid nitrogen contained in apparatus 400 not only can maintain the biological specimen under the cryogenic temperature environment, but also can help the function of the electrochemical doping reaction. Before the liquid nitrogen from the nozzle 414 entering the chamber 411, a filter paper (or a filter) has to be used to filter the ice crystals produced by the air moisture in contact with liquid nitrogen. The filter paper can prevent the ice crystals from entering the liquid nitrogen container and avoid the contamination of the biological specimen 405.

As shown in FIG. 4B, in the CryoECD process, the reaction of lithium electrode is the following:

Li→Li⁺+e⁻

The lithium ions released from the lithium electrode will be diffused into the lithium tetrafluoroborate polymer electrolyte. Under the condition of dynamic equilibrium, the lithium ions will hop into the liquid nitrogen from the opposite end of the electrolyte by the attraction of biological specimen electrode. And at this moment, the electrons from the cathode of battery will enter the biological specimen firstly, and hop along the electron hopping sites formed by the sodium ions. The lithium counter ions will diffuse into the amorphous-ice biological specimen to neutralize the electric charge of electrons that just injected into the biological specimen, in order to maintain the neutrality of biological specimen. During the process, because the concentration of original sodium chloride solution is high enough (about 200 μM or higher), when the amorphous-ice biological specimen is formed, nearly periodic sodium ions can provide very smooth electron hopping paths for electron transport, thus the electrons will not stay on the defects of water molecules to induce the dissociation of water molecules into hydroxyl ions. However, if the concentration of sodium chloride solution is not high enough, the injected electrons may cause the dissociation of water molecules due to variable-range hopping distance of electron. In the reaction process, when the number of injected electrons is not much at the beginning, the electron neutralized by the lithium counter ion will form a bound state with the adjacent sodium ion. Then, when the number of electrons and counter ions is increased to approach 200 μM, the electron wavefunction bound by sodium ion will overlap the adjacent electron wavefunctions. At this moment, the screening from electrons will destroy the bound states, and thus the electrons can move inside the amorphous-ice biological specimen freely in the form of traveling waves. This is the so-called Mott insulator-to-metal transition. Thus, after the lithium ion is doped to a certain concentration, the amorphous-ice biological specimen will become the conductor. The free electrons in biological specimen can be promptly returned to the ionized molecular fragments to repair the radiation damage of biomolecules under electron beam irradiation.

As shown in FIG. 4B, the equation of chemical reaction in the CryoECD process can be shown as follows:

(Na⁺Cl⁻ice)ₓ+Li_{(electrode)}→{(Li⁺)_{y}[(Na⁺Cl⁻ice)ₓ(e⁻)^{y}]}+[Li⁺(BF₄⁻)]_{(electrolyte)}

The equation of chemical reaction in the CryoECD process is an N-type doping reaction. The amorphous-ice biological specimen containing sodium and chlorine ions is an electrode and the lithium metal is a counter electrode. The reaction of the lithium electrode is:

Li→Li⁺+e⁻

The lithium ions released from the lithium electrode will be diffused into the amorphous-ice biological specimen containing sodium and chlorine ions. The (Na⁺Cl⁻ice)ₓ represents that there are x Na⁺ and C⁻ ions in the amorphous-ice biological specimen. The {(Li⁺)_{y}[(Na⁺Cl⁻ice)ₓ(e⁻)^{y}]} represents that there are y lithium ions and y electrons (e⁻) doped in the amorphous-ice biological specimen containing x Na⁺ and Cl⁻ ions. Lithium tetrafluoroborate (LiBF₄) salt is used as a low-temperature electrolyte. Practically, in order to prevent the electrons from being trapped by the defects of water molecules, and further inducing the dissociation of the water molecules into hydroxyl ions, the y value shall be not greater than x value. In addition, it will take several hours to complete the CryoECD process, thus it is necessary to keep the liquid nitrogen in pollution-free state for a long time.

In addition, sodium (or potassium) electrode can also be used as the counter electrode, and cooperate with the electrolyte of suitable sodium salts (or potassium salts) to carry out the same electrochemical doping. However, the sodium or the potassium ion is bigger than the lithium ion, thus its diffusion efficiency will be a little bit worse than that of the lithium ion.

After the CryoECD process is completed, the specimen grid containing the amorphous-ice biological specimen shall be removed and fixed on a low-temperature specimen holder. Then, the low-temperature specimen holder is sent into the electron microscope to carry out the imaging procedure. However, in the second preferred embodiment of the invention, the low-temperature specimen holder which originally comprises the amorphous-ice biological specimen after the CryoECD process can be directly sent into the electron microscope to carry out the imaging procedure.

A method for using the above-mentioned cryogenic electrochemical doping apparatus to form the biological specimen, comprising:

Carry out the low-temperature treatment at first, which is to add the low-temperature liquefied coolant in the container of the cryogenic electrochemical doping apparatus. Then the specimen grid containing the biological specimen is sent to the low-temperature liquefied coolant, after it is fixed on the low-temperature specimen holder. Finally, the cryogenic electrochemical doping is carried out in the biological specimen.

When the specimen is observed by the electron microscope, if a 4 k×4 k image detector (CCD) is used, the image resolution is about 1 angstrom per pixel at nominal magnification of 100,000×. Thus it has enough resolution to match with atomic model, which can become the bio-molecular electron microscope with atomic resolution directly.

From the aspect of energy band, the energy gap of any undoped water or amorphous ice is at least 6.9 eV. However, the energy gap of water or amorphous ice doped with sodium and chlorine ions will be reduced to below 1 eV due to the interaction between the doped ions and water molecules. Thus the amorphous ice containing a certain amount of sodium and chlorine ions will form an intrinsic semiconductor with good conductivity.

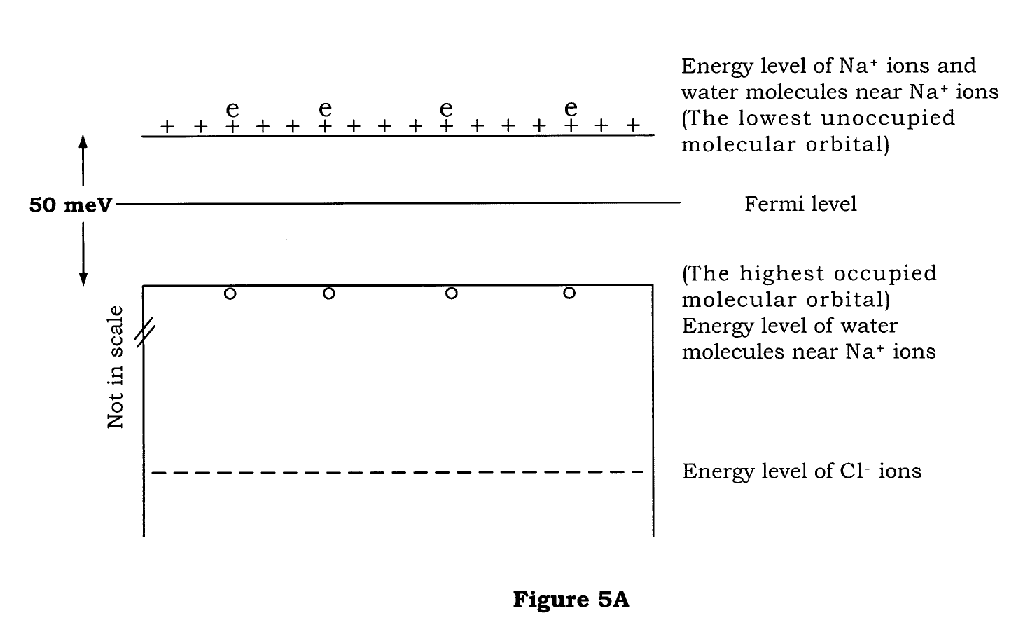

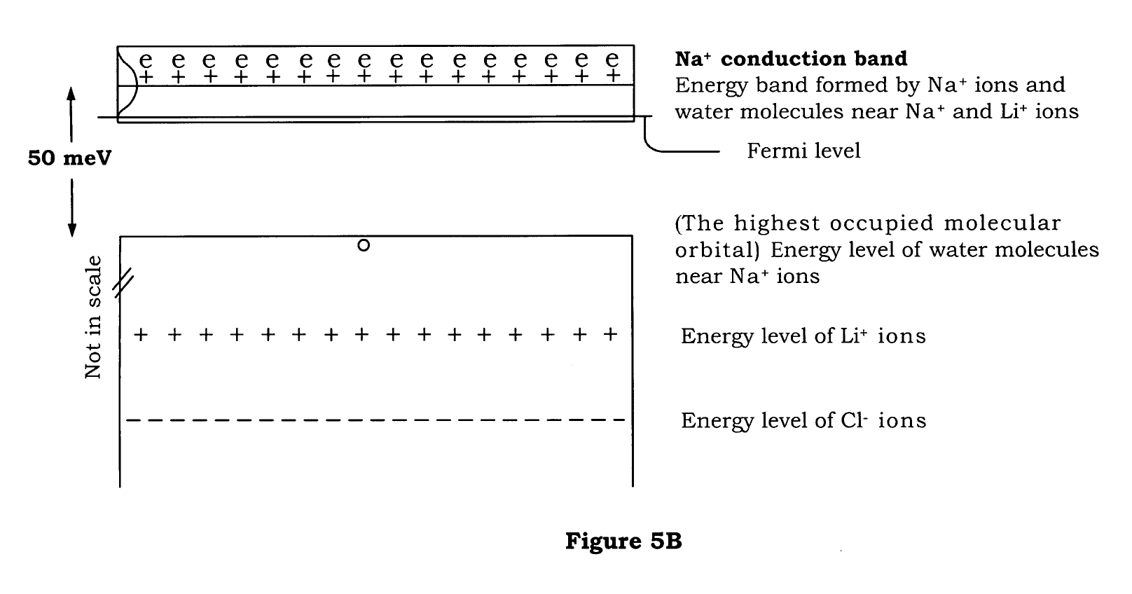

As shown in FIG. 5A, the lowest unoccupied molecular orbital (LUMO) in the energy band diagram is formed by the sodium ions and the polarized water molecules, and the highest occupied molecular orbital (HOMO) is formed by the polarized water molecules only. The energy gap between LUMO and HOMO is only 50 meV. The Fermi level (EF) lies in the middle of LUMO and HOMO approximately. The carriers in the amorphous ice are electrons (e) and holes (h) of equal amount, which are located at the LUMO and HOMO, respectively. Thus, in the amorphous ice containing the sodium and chlorine ions, the conduction level (LUMO) formed by the sodium ions and polarized water molecules is responsible for the electron transport. However, the product of the numbers of the electrons and holes is a constant value in an intrinsic semiconductor. Thus, further N-type doping is necessary to be conducted to increase the number of free electrons to enable the amorphous ice have the behavior close to the conductor.

Because the amorphous-ice biological specimen containing sodium and chlorine ions is only an intrinsic semiconductor, and the biological specimen is frozen and stored in a specimen grid with gold (5 nm) coated holey carbon film (the size of carbon film holes for storing the biological specimens is about 2-4 μm in diameter) (as shown in FIG. 1), when the CryoECD process is conducted, it is unable to inject larger current into the biological specimen. So, it usually takes several hours for the charging reaction of CryoECD process. In addition, the doped amorphous ice should belong to an organic semiconductor, and there are a lot of interfacial states at the interface between the doped amorphous ice and metal. These interfacial states can facilitate the injection of electrons, but a certain barrier exists due to the band bending at the doped amorphous ice-metal interface. This barrier will restrain the probability of the injection of electrons from metal to the doped amorphous ice. Thus, in order to shorten the reaction time of CryoECD process, it can be considered to sputter the aluminum metal on the holey carbon film of specimen grid to reduce the interfacial barrier. With the charging time is increased, the number of electrons occupied on the conduction level (LUMO) is also increased. The Fermi level will thus be raised constantly. Therefore, the number of electrons injected from the metal into the amorphous-ice biological specimen will also be increased continuously. However, during the CryoECD process, doping lithium ions (counter ions) will assure charge neutrality of the amorphous-ice biological specimen, and the injected electrons will form bound states with neighboring sodium ions or lithium ions first.

Then, when the number of electrons and lithium ions is increased to approach 200 μM, the electron wavefunction bound by sodium ion will overlap the adjacent electron wavefunctions. At this moment, the screening from electrons destroys the bound states, and the electrons will move inside the amorphous-ice biological specimen freely in the form of traveling waves. Thus, after the lithium ion is doped to a certain concentration, the amorphous-ice biological specimen will become the conductor.

As the energy band diagram shown in FIG. 5B, after a certain amount of lithium ions is doped, the water molecules near lithium ions will be polarized, and the Coulomb interaction between lithium ions and sodium ions will make the water molecules near sodium and lithium ions to form the energetically disordered states. These disordered states can form a broad conduction band for electron transport, which is called as the Na⁺ conduction band. In addition, the doping of lithium ions will increase the number of electrons occupied in the Na⁺ conduction band, so that the Fermi level will be lifted up greatly. The raised Fermi level will overlap the Na⁺ conduction band, so that the amorphous-ice biological specimen after being doped with a certain amount of lithium ions can become the conductor.

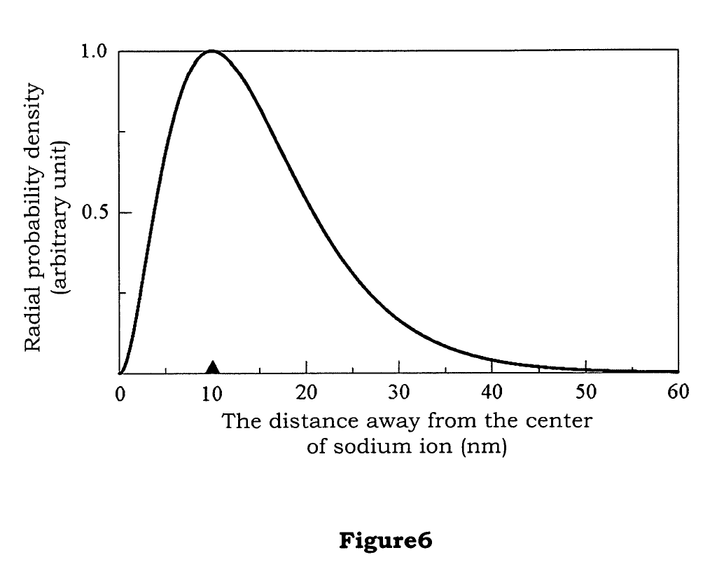

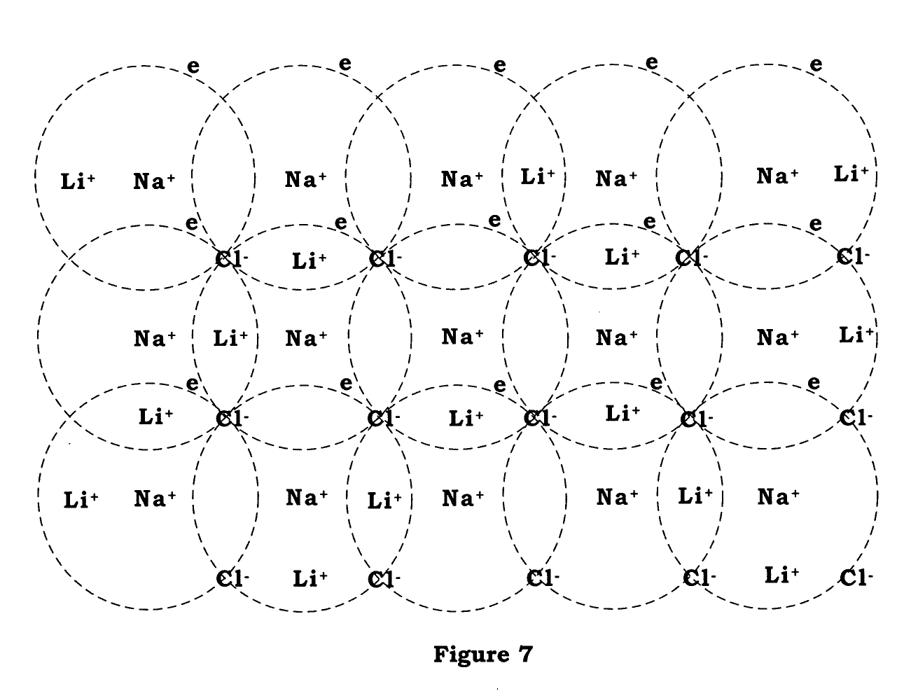

As shown in FIG. 6, the radial probability distribution of the electron wavefunction bound around sodium ion in the amorphous ice is illustrated. The abscissa is the distance away from the center of sodium ion. The effective electron mass (mₑ) can be estimated to be about 0.25 mₑ in the amorphous ice after the CryoECD process, because the distribution of sodium ions and chlorine ions is very uniform in the aqueous solution before rapid freezing. In addition, assume the dielectric constant of the amorphous ice is about 60, the radius of the spread of the electron wavefunction bound around sodium ion in the amorphous ice will be about 10 nm based on the calculation using the theory of Bohr model. The radius can be shown by the dotted circle in FIG. 7. When the average distance between the adjacent sodium ions is smaller than or equal to 14 nm, the concentration of sodium ions will be about 200 μM in this circumstance. As shown in FIG. 7, the overlap of the electron wavefunctions will be large, and all space of the amorphous ice will be covered by the extent of the spread of the electron wavefunctions.

Meantime, large overlap of the electron wavefunctions can destroy the electron bound states by sodium ions, and the electrons can freely move in the amorphous-ice biological specimen in the form of traveling waves. Thus, after the lithium ion is doped to a certain concentration, the amorphous-ice biological specimen will become the conductor. At this moment, the lithium ions play the function of counter ions to neutralize the charge of free electrons in the amorphous-ice biological specimen. Namely in every range of the electron wavefunction, there exists at least a lithium ion to assure the charge neutrality condition. Thus, if the spin direction of electron is not considered, the number of free electrons stored in the amorphous-ice biological specimen will equal to the number of doped lithium ions.

Generally speaking, the effective charge of water solvated sodium ion is at least about 0.6 e. Based on the estimation using Bohr model, the bound energy of sodium ion on electron in the amorphous ice will be about 1.3 meV. The kinetic energy of electron is 6 meV at 77K, and it is larger than the bound energy (1.3 meV) of sodium ion on electron in the amorphous ice. Therefore, the electrons still can move freely in the doped amorphous ice even at about 77K, and the free electrons can be described by the wavefunctions in the form of traveling waves.

Moreover, the overlap of the adjacent electron wavefunctions may be larger, so that the electron mobility in the lithium ion doped amorphous ice can be much closer to that of the conductor. Thus, when the ice-embedded biological molecules are damaged under the electron beam irradiation, the free electrons in the lithium ion doped amorphous ice can be promptly returned to the ionized atoms and molecular fragments to repair the radiation damage of the biological molecules.

In addition, after the charging process of the invention, it is almost impossible for the free electrons to escape out from the amorphous-ice biological specimen. Because the average kinetic energy of electrons is only 6 meV at 77K, which is much smaller than about 0.3 eV energy barrier at the aluminum metal-amorphous ice interface. Thus, if no bias voltage is applied, the free electrons in the amorphous-ice biological specimen are very difficult to cross over the interfacial energy barrier and enter aluminum metal. Hence, the free electrons can be kept in the lithium ion doped amorphous-ice biological specimen for a long time. Moreover, the free electrons stored in the doped amorphous-ice biological specimen can move freely and be distributed evenly in the Na+ conduction band.

In addition, as for the repair mechanism of radiation damage, because the phonon relaxation time of the amorphous-ice biological specimen is about 10⁻¹⁰ seconds, the ionized protein fragments and the water molecule free radicals caused by electron radiation will have slight displacement or motion after 10⁻¹⁰ seconds. Though the time of the occurrence of atom and molecule displacement can be delayed when biological specimen is kept at the cryogenic temperatures, the permanent radiation damage caused by the electron irradiation cannot be scavenged thoroughly. Thus, only when the amorphous-ice biological specimen becomes the conductor and its electron mobility is close to that of the conductor, the electrons can be returned to ionized protein fragments and water free radicals before the phonon relaxation takes place to repair the radiation damage in the frozen biological specimen. The reason is after the amorphous-ice biological specimen becomes the conductor, the migration speed of free electrons is much quicker than 10⁻¹⁰ seconds of phonon relaxation time.

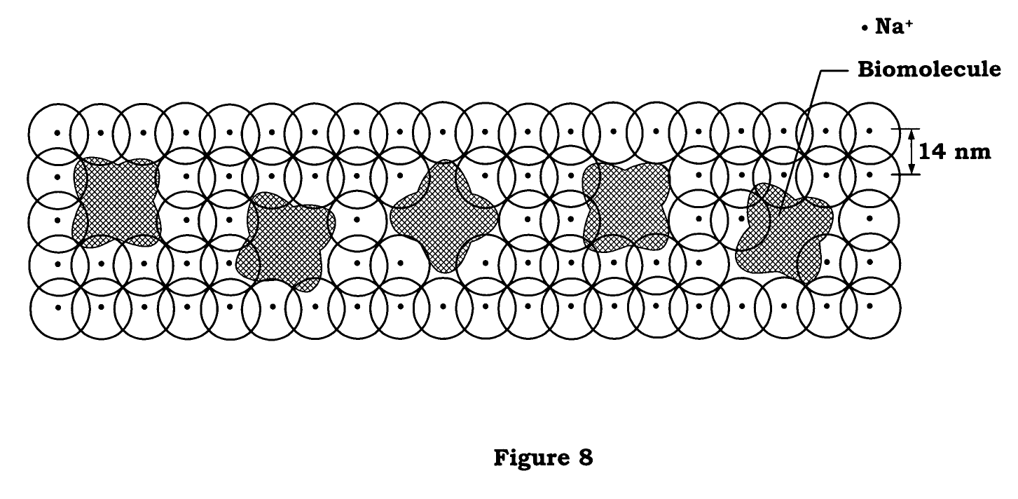

As shown in FIG. 8, the lithium and chlorine ions are not shown for simplicity. When the average distance between the adjacent sodium ions is less than or equal to 14 nm, the concentration of sodium ions is about 200 μM in this circumstance. The extent of the spread of the electron wavefunctions around sodium ions will overlap the ice-embedded biological protein molecules (here about 30 nm in size). The radius range (shown by the circle of 10 nm radius in FIG. 8) of the electron wavefunction around each sodium ion represents the scope for coherent electron tunneling. At this moment, the protein molecule is looked like to be embedded in the environment of a conductor. Thus, when the protein molecules embedded in the amorphous ice are damaged by the irradiation of electron beam, the free electrons in the lithium ion doped amorphous ice can promptly tunnel into the protein molecules to repair the ionized molecular fragments which lose electrons under electron irradiation. The electrons after entering into the protein molecule can promptly tunnel or diffusively hop through the damaged protein molecule to repair the ionized atoms and molecular fragments (frozen free radicals) in it.

Moreover, in order to reach higher efficiency in repairing the radiation damage, and further raise the electron dosage tolerance of biological molecule, in fact it can be considered to increase the doping amount of sodium ions, chlorine ions and lithium ions in the amorphous-ice biological specimen to several mM or more, and this doping amount will not influence the contrast and resolution of the electron microscope. Because the projection matching is often used as the image analysis technique in the image reconstruction of biological molecule, thus such small amount of ion doping will not influence the reconstruction result of three-dimensional molecular structure after applying many times of projection matching in the image analysis. Therefore, after doping the extra cations by the CryoECD method, the free electrons stored in the amorphous-ice biological specimen containing sodium ions, chlorine ions and lithium ions can be promptly returned to scavenge the ionized molecular fragments and water free radicals caused by electron irradiation, and thus greatly reduce or even eliminate the radiation damage in the biological molecules and their surrounding amorphous ice environment under the electron beam exposure. In the other words, the invention can raise the electron dosage tolerance of biological molecule, and can improve the resolving ability of electron microscope on the biological molecule to near atomic resolution effectively.

In a preferred embodiment of the invention, as for the electrolyte used for the doping of biological molecule solution, the cation is sodium ion mainly, and the other cation like potassium, calcium, or magnesium ion can also be used. The anion includes the chlorine ion, hydrogen carbonate ion (HCO₃_{^{−}}) or di-hydrogen phosphate ion (H₂PO₄_{^{−}}) etc.; or the amino acids with positive or negative charge; or other molecules with positive or negative charge etc.

In addition, after the biological molecule solution containing electrolyte is rapidly freezing, when the CryoECD method is used to dope the amorphous-ice biological specimen, the cation used for doping can be lithium ion, sodium ion, or potassium ion etc. And after the cation is doped to a certain concentration, the amorphous-ice biological specimen will become the conductor. Thus, under the irradiation of electron beam, the free electrons stored in the doped amorphous-ice biological specimen can be promptly returned to the damaged molecular fragments and water free radicals to repair and scavenge the radiation damage in the biological molecules and their surrounding amorphous ice environment.

The main feature of the invention is the following:

Different doping procedure is carried out before and after rapid freezing the biological molecule solution. Firstly, a certain amount of suitable electrolyte is doped in the biological molecule solution, so that the biological molecule solution after rapid freezing will become the electrolyte ions doped amorphous-ice biological specimen and own the characteristics of semiconductor. Then, after rapid freezing the biological molecule solution, the electrochemical doping (ECD) is employed to dope the amorphous-ice biological specimen at the cryogenic temperature. After a certain amount of cation doping, the N-type doped amorphous-ice biological specimen will have the behavior close to the conductor. Thus the invention can form N-type doping in the amorphous-ice biological specimen successfully. And during N-type doping process, it will not cause the water molecules in the amorphous ice to trap electrons and be dissociated into the hydroxyl ions. Meantime, it will not damage the structure of biological molecule.

The invention can make N-type doped amorphous ice having the property of conductor. The free electrons stored in the N-type doped amorphous-ice biological specimen can be promptly returned to scavenge the ionized protein fragments and water free radicals which lose electrons under electron irradiation, and thus greatly reduce the radiation damage of the protein molecules and the surrounding amorphous ice during the electron beam exposure. Thus, enough electron dosage can be provided to observe the prototype of biomaterials clearly.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A method for forming a biological specimen of electron microscope, comprising:
adding a biological molecule in an electrolyte solution to form as a biological molecule solution;
rapid freezing the biological molecule solution to form as a biological specimen; and
carrying out a cryogenic electrochemical doping in the biological specimen to form the biological specimen of electron microscope.

2. The method according to claim 1, wherein the electrolyte solution comprises a certain amount of anions and a certain amount of cations.

3. The method according to claim 2, wherein the anion is selected from the group consisting of chlorine ion, hydrogen carbonate ion, and dihydrogen phosphate ion.

4. The method according to claim 1, wherein the electrolyte solution comprises a sodium ion.

5. The method according to claim 1, wherein the concentration of the electrolyte solution is between about 1 μM and 150 mM.

6. The method according to claim 1, wherein the rapid freezing comprises the rapid freezing by a low-temperature liquefied ethane.

7. The method according to claim 1, wherein the biological specimen generated by rapid freezing comprises the amorphous-ice biological specimen.

8. The method according to claim 1, wherein the cryogenic electrochemical doping comprises a charging function to the biological specimen.

9. A cryogenic electrochemical doping apparatus for forming a biological specimen, comprising:
a biological specimen installed in a cryogenic electrochemical doping apparatus, the biological specimen being as a first electrode of the cryogenic electrochemical doping apparatus, the biological specimen being connected to a cathode of a battery via a specimen electrode bar;
a second electrode connected to an anode of the battery, the biological specimen being immersed in a low-temperature liquefied coolant, the low-temperature liquefied coolant being contained in a container; and
an electrolyte used in a cryogenic electrochemical doping reaction for forming the cryogenic electrochemical doping apparatus of the biological specimen.

10. The apparatus according to claim 9, wherein the cryogenic electrochemical doping apparatus further comprises a gas injection tube.

11. The apparatus according to claim 9, wherein the cryogenic electrochemical doping apparatus further comprises a chamber.

12. The apparatus according to claim 11, wherein the chamber comprises the container of the low-temperature liquefied coolant.

13. The apparatus according to claim 11, wherein the chamber comprises a closed chamber.

14. The apparatus according to claim 13, wherein the closed chamber comprises a nozzle for the injection of the low-temperature liquefied coolant.

15. The apparatus according to claim 11, wherein the chamber comprises a partially closed chamber.

16. The apparatus according to claim 9, wherein the second electrode is selected from the group consisting of lithium metal, sodium metal, and potassium metal.

17. The apparatus according to claim 9, wherein the low-temperature liquefied coolant comprises a liquid nitrogen.

18. The apparatus according to claim 9, wherein the cryogenic electrochemical doping reaction comprises a charging function to the biological specimen.

19. The apparatus according to claim 9, wherein the electrolyte is selected from the group consisting of lithium tetrafluoroborate, lithium perchlorate, lithium hexafluorophosphate, and lithium hexafluoroarsenate.

20. The apparatus according to claim 9, wherein the electrolyte comprises sodium salts.

21. The apparatus according to claim 9, wherein the electrolyte comprises potassium salts.

22. A cryogenic electrochemical doping apparatus for forming a biological specimen, comprising:
a biological specimen installed in a cryogenic electrochemical doping apparatus, the biological specimen being as a first electrode of the cryogenic electrochemical doping apparatus, the biological specimen being connected to a cathode of a battery via an electric wire from a metal bar installed in a Dewar bottle;
a second electrode connected to an anode of the battery, the biological specimen being immersed in a low-temperature liquefied coolant, the low-temperature liquefied coolant being contained in a container; and
an electrolyte used in a cryogenic electrochemical doping reaction for forming the cryogenic electrochemical doping apparatus of the biological specimen.

23. The apparatus according to claim 22, wherein the cryogenic electrochemical doping apparatus further comprises a gas injection tube.

24. The apparatus according to claim 22, wherein the cryogenic electrochemical doping apparatus further comprises a chamber.

25. The apparatus according to claim 24, wherein the chamber comprises the container of the low-temperature liquefied coolant.

26. The apparatus according to claim 24, wherein the chamber comprises a closed chamber.

27. The apparatus according to claim 26, wherein the closed chamber comprises a nozzle for the injection of the low-temperature liquefied coolant.

28. The apparatus according to claim 24, wherein the chamber comprises a partially closed chamber.

29. The apparatus according to claim 22, wherein the second electrode is selected from the group consisting of lithium metal, sodium metal, and potassium metal.

30. The apparatus according to claim 22, wherein the low-temperature liquefied coolant comprises a liquid nitrogen.

31. The apparatus according to claim 22, wherein the cryogenic electrochemical doping reaction comprises a charging function to the biological specimen.

32. The apparatus according to claim 22, wherein the electrolyte is selected from the group consisting of lithium tetrafluoroborate, lithium perchlorate, lithium hexafluorophosphate, and lithium hexafluoroarsenate.

33. The apparatus according to claim 22, wherein the electrolyte comprises sodium salts.

34. The apparatus according to claim 22, wherein the electrolyte comprises potassium salts.

35. A method for using a cryogenic electrochemical doping apparatus to form a biological specimen, comprising:
carrying out a low-temperature treatment, the low-temperature treatment being to add a low-temperature liquefied coolant into a container of a cryogenic electrochemical doping apparatus;
transferring a specimen grid to the low-temperature liquefied coolant, the specimen grid having a biological specimen; and
carrying out a cryogenic electrochemical doping reaction in the biological specimen.

36. The method according to claim 35, wherein the container is wrapped by a polystyrene material.

37. The method according to claim 35, wherein transferring the specimen grid to the low-temperature liquefied coolant comprises fixing the specimen grid on a specimen electrode bar and sending to the low-temperature liquefied coolant.

38. The method according to claim 35, wherein transferring the specimen grid to the low-temperature liquefied coolant comprises using a low-temperature specimen holder to fix the specimen grid and sending to the low-temperature liquefied coolant.
